(19) United States
(12) Patent Application Publication
(10) Pub. No.: US 2015/0348005 A1
(43) Pub. Date: Dec. 3, 2015

(54) SYSTEM FOR WIRELESSLY TRANSMITTING TRANSACTION DATA TO A MOBILE COMPUTING DEVICE OF A USER

(71) Applicant: TOSHIBA TEC KABUSHIKI KAISHA, Tokyo (JP)

(72) Inventor: Nobuhiro INAGAWA, Mishima Shizuoka (JP)

(21) Appl. No.: 14/721,917

(22) Filed: May 26, 2015

(30) Foreign Application Priority Data
May 28, 2014 (JP) 2014-110393

(51) Int. Cl. G06Q 20/32

(52) U.S. Cl. CPC G06Q 20/3224

(57) ABSTRACT

A system includes a server, a local positioning system of a store, and a mobile computing device of a user. The server stores transaction data of a transaction carried out by a user at the store, first additional information associated with the store, and second additional information. The mobile computing device is configured to determine whether or not the mobile computing device is within the store based on one or more local positioning signals from the local positioning system and transmit position information of the mobile computing device including the determination result to the server. The server is configured to transmit, to the computing device, the transaction data and the first additional information when the position information indicates that the mobile computing device is within the store, and the transaction data and the second additional information when the position information indicates that the mobile computing device is outside the store.

### CROSS-REFERENCE TO RELATED APPLICATION

This application is based upon and claims the benefit of priority from Japanese Patent Application No. 2014-110393, filed May 28, 2014, the entire contents of which are incorporated herein by reference.

### FIELD

Embodiments described herein relate generally to a system for wirelessly transmitting transaction data, such as electronic receipt data, to a mobile computing device of a user.

### BACKGROUND

An electronic receipt system transmits electronic data of a purchase transaction at a store (i.e., an electronic receipt) to a computing device of a customer, such as a mobile computing device, instead of issuing a conventional paper receipt that is handed to the customer upon completion of the purchase transaction.

The electronic receipt is useful to the customer, because the customer can manage his or her purchase transactions electronically. Further, the electronic receipt is useful to the store, because the store can reduce paper usage and with full conversion, will not need to invest in machines that issue the paper receipt. In addition, providing electronic receipts instead of paper receipts may reduce the time necessary to carry out settlement processing for the purchase transaction.

An electronic receipt system of one type attaches additional information such as coupon information to the electronic data of the purchase transaction. It would be preferable to attach additional information useful to the customer (i.e., information demanded by the customer).

### DESCRIPTION OF THE DRAWINGS

FIG. 1 illustrates an entire configuration of an electronic receipt system according to an embodiment.

FIG. 2 is a block diagram of a POS terminal in the electronic receipt system.

FIG. 3 is a block diagram of an electronic receipt server in the electronic receipt system.

FIG. 4 is a block diagram of an electronic receipt management server in the electronic receipt system.

FIG. 5 illustrates a data structure of a memory region in a storage unit of the electronic receipt management server.

FIG. 6 illustrates a data structure of another memory region in the storage unit of the electronic receipt management server.

FIG. 7 is a block diagram of a mobile terminal in the electronic receipt system.

FIG. 8 illustrates detection of local positioning signal from beacons by the mobile terminal at different locations.

FIG. 9 is a flowchart illustrating a flow of control processing carried out by the POS terminal.

FIG. 10 is a flowchart illustrating a flow of control processing carried out by the electronic receipt server.

FIG. 11 illustrates functional blocks of the electronic receipt management server.

FIG. 12 is a flowchart illustrating a flow of control processing carried out by the electronic receipt management server.

FIG. 13 is a flowchart illustrating a flow of control processing carried out by the mobile terminal.

FIG. 14 illustrates an example of a display screen of the mobile terminal.

### DETAILED DESCRIPTION

An embodiment provides an electronic receipt management server and a program by which suitable additional information is able to be transmitted according to a location of a customer along with an electronic receipt.

In general, according to one embodiment, a system for wirelessly transmitting transaction data to a mobile computing device carried by a user, includes a server, a local positioning system of a store, and a mobile computing device. The server stores transaction data of a purchase transaction carried out by the user at the store, first additional information associated with the store, and second additional information that is different from the first additional information. The mobile computing device of the user is configured to determine whether or not the mobile computing device is within the store based on one or more local positioning signals received from the local positioning system and transmit position information of the mobile computing device including the determination result to the server. The server is configured to transmit, to the computing device, the transaction data and the first additional information when the position information indicates that the mobile computing device is within the store, and the transaction data and the second additional information when the position information indicates that the mobile computing device is outside the store.

Hereinafter, an embodiment will be described with reference to the drawings. However, the present disclosure is not limited to the embodiment described below.

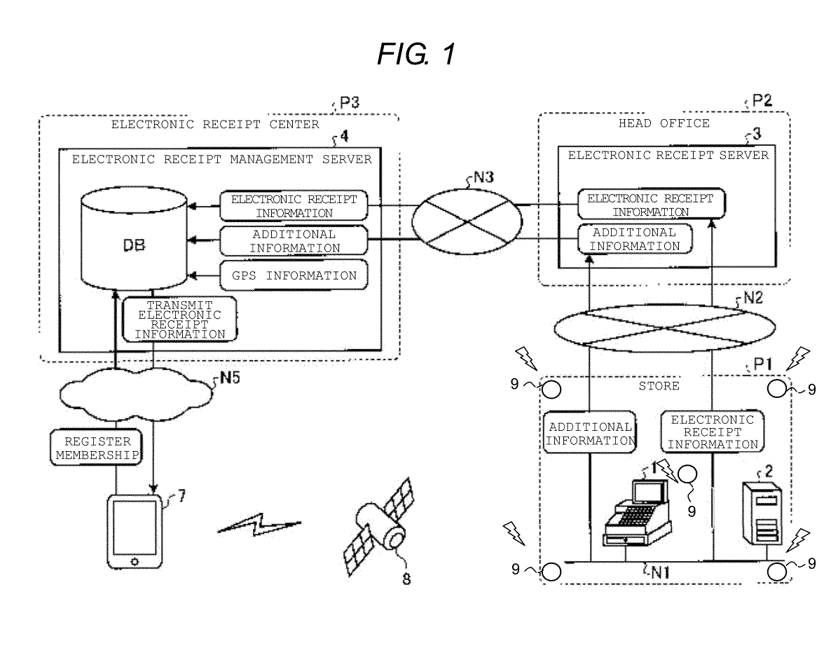

FIG. 1 illustrates the entire configuration of an electronic receipt system according to an embodiment. As illustrated in FIG. 1, the electronic receipt system includes a Point of Sales (POS) terminal 1, a store server 2, an electronic receipt server 3, an electronic receipt management server 4, a mobile terminal 7 carried by a customer, and a plurality of beacons 9.

The POS terminal 1, the store server 2, and the beacons 9 are located in a store P1. The POS terminal 1 and the store server 2 are connected to a network N1 such as a Local Area Network (LAN) in the store so as to be able to communicate with each other. The beacons 9 are also connected to the network N1 wirelessly or with wires, and each of the beacons 9 generates a local positioning signal. In addition, the POS terminal 1 and the store server 2 are able to be connected to a network N2 connecting the store P1 to a head office P2 through a network equipment (not illustrated) such as a router which is connected to the network N1 in the store. Here, the network N2, for example, is a dedicated line such as the Internet or a Virtual Private Network (VPN).

The POS terminal 1 is a merchandise sales data processing device that performs merchandise sales data processing. The POS terminal 1 generates receipt information (a non-structured format) including contents of a purchase transaction, and outputs a paper receipt by printing the receipt information using a printing unit 13 (described below). In addition, the POS terminal 1 converts a data format of the receipt information into a structured format and generates electronic receipt information, and outputs (transmits) the generated electronic receipt information to the electronic receipt server 3 through the network N2. A transmission method of electronic receipt information is not particularly limited, and a general-purpose protocol such as HTTP or HTTPS may be used. Furthermore, the number of POS terminals 1 located in the store P1 is not particularly limited, and a plurality of POS terminals 1 may be disposed.

The store server 2 integrally manages operations, such as the merchandise sales data processing, which are performed by the POS terminal 1. For example, the store server 2 collects, stores, and manages merchandise sales data which is generated during the merchandise sales data processing in the POS terminal 1, or stores and manages a merchandise data file or the like which is used in the merchandise sales data processing.

In addition, the store server 2 transmits information of merchandise, such as special on-sale merchandise or new merchandise in the store P1, which are planned to be advertised by the store, information of a coupon which is able to be used with respect to these merchandises, and the like (the information is collectively referred to as “additional information”), to the electronic receipt server 3 through the network N2. Alternatively, the POS terminal 1 may transmit the additional information to the electronic receipt server 3.

Furthermore, in this embodiment, the POS terminal 1 converts the receipt information, and generates and outputs the electronic receipt information, but the configuration is not limited thereto. For example, the store server 2 or a conversion device (not illustrated) may convert the data format of the receipt information generated by the POS terminal 1, and generate and output the electronic receipt information to the electronic receipt server 3.

The electronic receipt server 3 is located in a head office P2 of a company which operates one or more stores or chain stores (hereinafter, referred to as “store”), and functions as a receipt management server for the company.

In addition, the electronic receipt server 3 receives the electronic receipt information transmitted from the POS terminal 1 through the network N2. In addition, the electronic receipt server 3 transmits the received electronic receipt information to the electronic receipt management server 4 through a network N3 connecting the head office P2 and an electronic receipt center P3.

In addition, the electronic receipt server 3 receives the additional information transmitted from the POS terminal 1 or the store server 2 through the network N2. In addition, the electronic receipt server 3 transmits the received additional information to the electronic receipt management server 4 through the network N3.

Here, the network N3, for example, is a dedicated line such as the Internet or VPN. In addition, a transmission method of electronic receipt information is not particularly limited, and a general-purpose protocol such as HTTP or HTTPS may be used.

The electronic receipt management server 4 is located in the electronic receipt center P3. The electronic receipt center P3 is, for example, a third-party organization other than the companies, each of which manages the electronic receipt information using the electronic receipt server 3. Alternatively, the third-party organization or the like may also manage the electronic receipt server 3 as well as the electronic receipt management server 4.

The electronic receipt management server 4 functions as a receipt management server for customers and collectively manages the electronic receipt information of multiple companies each of which operates one or more stores. The electronic receipt management server 4 stores membership data, such as a name or a membership code (a customer code) of each customer (member) who is subjected to membership registration by a procedure or the like described below, a terminal code for specifying the mobile terminal 7, and transmission destination information (for example, an email address) associated with the mobile terminal 7, which is a transmission destination of the electronic receipt information in a membership master maintained in database DB, and manages the data. Furthermore, a membership management server or the like which stores and manages the membership data may be separated from the electronic receipt management server 4.

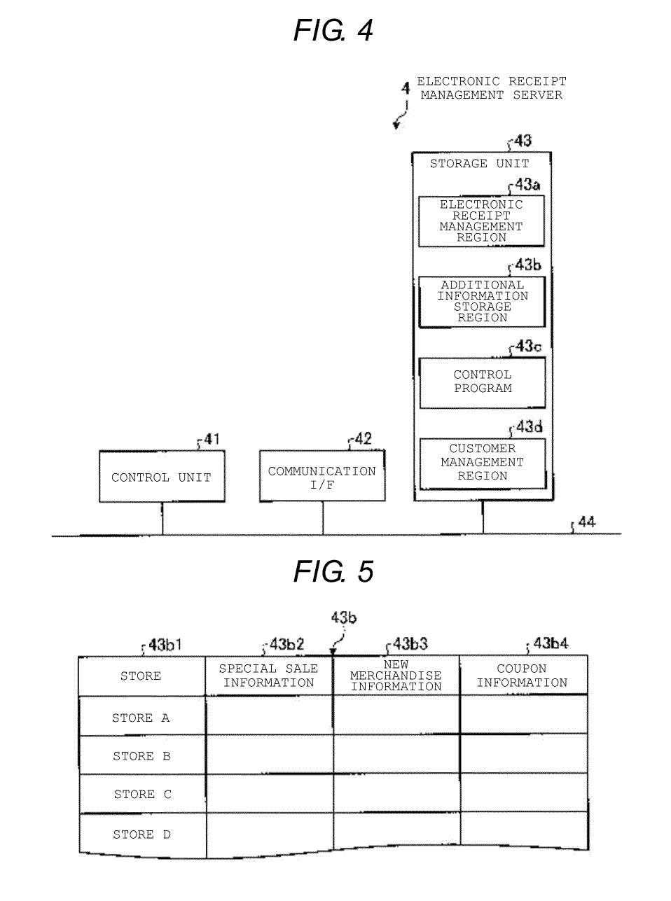

In addition, the electronic receipt management server 4 receives the electronic receipt information transmitted from the electronic receipt server 3 through the network N3, stores the electronic receipt information in an electronic receipt management region 43a (described below) in the database DB, and manages the electronic receipt information (refer to FIG. 4). More specifically, the electronic receipt information includes data elements, such as store information of the store transmitting the electronic receipt information or a membership code, in addition to contents (merchandise sales data) of the purchase transaction, and is managed in correlation with the membership data of the corresponding membership.

In addition, when the electronic receipt information is stored in the database DB, the electronic receipt management server 4 specifies the transmission destination (the mobile terminal 7) by referring to the transmission destination information correlated with the membership code of the electronic receipt information. Then, the electronic receipt management server 4 notifies the transmission destination that there is the electronic receipt information to be transmitted through a network N5 (FIG. 1).

In addition, when an electronic receipt inquiry associated with a membership code is received from the mobile terminal 7 connected through the network N5, the electronic receipt management server 4 extracts the electronic receipt information associated with the membership code from the database DB, and transmits the electronic receipt information to the mobile terminal 7. Furthermore, when the additional information is correlated with the electronic receipt information, the additional information is also transmitted to the mobile terminal 7 which inquires about the additional information.

The mobile terminal 7 is a terminal device such as a smart phone, a mobile phone, Personal Digital Assistant (PDA), or a tablet computer, which is used and carried by a user (the customer) of the electronic receipt system. The mobile terminal 7 implements an application such as a Web browser for displaying various kinds of information provided on the network N5.

The mobile terminal 7 accesses the electronic receipt management server 4 through the network N5, and performs the membership registration with respect to the electronic receipt system. Here, the network N5 is the Internet or various public networks.

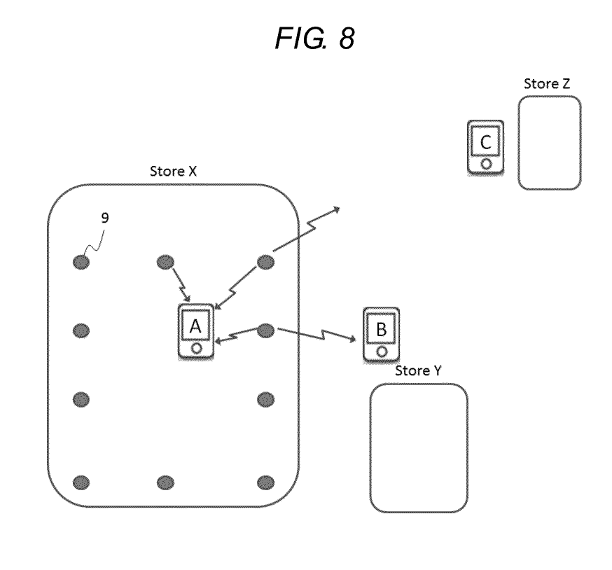

The mobile terminal 7 includes a known Global Positioning System (GPS) unit 77 (refer to FIG. 7), and the GPS unit 77 is able to specify the position of the mobile terminal 7 by catching a signal output from a plurality of GPS satellites 8 circling around the earth. The mobile terminal 7 transmits position information of the mobile terminal 7 specified by the GPS unit 77 to the electronic receipt management server 4 through the network N5 periodically (for example, every 1 second).

The mobile terminal 7 also includes a local positioning module 78, which is connected to the bus 76 and detects the local positioning signal transmitted from any one of the beacons 9 when the mobile terminal 7 is within range thereof. In response to receiving the signals through the local positioning module 78 from the beacons 9, the local positioning module 78 can determine whether or not the mobile terminal 7 is located within the store P1 or outside the store P1, e.g., by triangulation techniques. If the local positioning module 78 determines that the mobile terminal 7 is within the store P1, accesses the store server 2 connected to the beacon 9 and obtains information of the store P1, such as a store code and a store address, from the store server 2.

The membership registration of the customer in the electronic receipt system, for example, is performed according to the following procedure. The customer transmits a blank mail to the electronic receipt management server 4 from the mobile terminal 7 through the network N5. The electronic receipt management server 4 transmits a Uniform Resource Locator (URL) of a web page for the membership registration to the received email address. The customer accesses the web page for the membership registration from the mobile terminal 7, and displays an input screen through which items (a name, transmission destination information, and the like) necessary for the membership registration are input. After terminating the input of the necessary items by the customer, the electronic receipt management server 4 performs the membership registration with respect to the membership master. After that, the electronic receipt management server 4 delivers a membership registration completion mail including a membership code (a customer code) and a (tentative) password to the mobile terminal 7. Accordingly, the membership registration is terminated.

In addition, after the settlement (transaction) in the POS terminal 1, the mobile terminal 7 receives a notification that the electronic receipt information is available from the electronic receipt management server 4 through the network N5. The member operates the mobile terminal 7, and a request for the electronic receipt information is transmitted to the electronic receipt management server 4 through the network N5, and the electronic receipt information and the additional information of the member are received from the electronic receipt management server 4. In addition, the mobile terminal 7 displays the received electronic receipt information and the additional information.

In the electronic receipt system according to the present embodiment, the electronic receipt information indicating the content of the transaction (the settlement) generated by performing the merchandise sales data processing in the POS terminal 1 of the store P1 is transmitted to the electronic receipt management server 4 through the electronic receipt server 3, and is uploaded on the Web. Therefore, when the mobile terminal 7 implementing the Web browser designates the Uniform Resource Locator (URL), the receipt information uploaded on the Web is able to be downloaded to the mobile terminal 7 and displayed using the Web browser. Furthermore, an application for displaying the receipt information on the mobile terminal 7 may be installed and displayed.

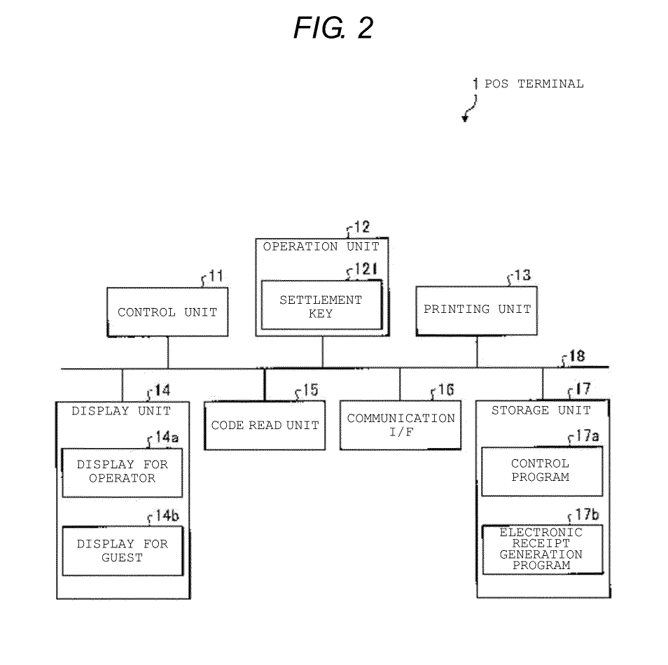

Next, hardware configuration of main devices in the electronic receipt system according to this embodiment will be described with reference to FIG. 2 to FIG. 7.

First, the POS terminal 1, which is the merchandise sales data processing device, will be described. FIG. 2 is a block diagram of the POS terminal 1. As illustrated in FIG. 2, the POS terminal 1 includes a control unit 11 which integrally controls various calculations or each unit of the POS terminal 1. The control unit 11 includes a Central Processing Unit (CPU), a Read Only Memory (ROM) storing various programs or data, a Random Access Memory (RAM) that temporarily stores various programs or rewritably stores various data, a Real Time Clock (RTC) unit that indicates current date and time, and the like.

The control unit 11 is connected to an operation unit 12, a printing unit 13, a display unit 14, a code read unit 15, a communication I/F 16, and a storage unit 17, through a bus 18.

The operation unit 12 includes various operation keys for performing input operations by an operator. As the operation key, for example, a register key for inputting a numerical value, a cursor key for selecting a predetermined item, a selection determination key, a settlement key 121 performing settlement processing of one transaction and terminating the transaction, and the like, are disposed.

The printing unit 13 is a printer device printing the receipt, a journal, or the like. The printing unit 13, for example, prints receipt information including information of purchased merchandise, settlement information according to the settlement processing, and the like on rolled paper transported through a thermal head including a heating medium, and then cuts the paper, and as a result a receipt is issued.

The display unit 14, for example, is a liquid crystal display or the like, and displays various kinds of information, such as the product name of the merchandise subjected to the sales registration, the price, a total price of one transaction in which the settlement is declared, and a change sum. The display unit 14 includes a display 14a for an operator, which displays various kinds of information to a cashier, and a display 14b for a guest, which displays various kinds of information to the customer. Furthermore, the display unit 14 may include a touch panel, and in this case, the touch panel functions as the operation unit 12.

The code read unit 15, for example, is a scanner device that optically reads a code symbol, such as a bar code or a two-dimensional code. The code read unit 15, for example, reads a code symbol applied to the merchandise, a code symbol displayed on a display unit of the mobile terminal 7, or the like, and the control unit 11 operates to maintain information included in the read code symbol. Furthermore, in the code symbol applied to the merchandise, a merchandise code for specifying the merchandise or the like is included. In addition, in the code symbol displayed on the mobile terminal 7, a membership code (a customer code) for specifying the customer carrying the mobile terminal 7 or the like is included. Furthermore, the membership code may be magnetically or electrically stored in the mobile terminal 7. In this case, the stored membership code is read by a dedicated reading device. The control unit 11 operates to maintain the read membership code.

The control unit 11 is connected to a communication I/F (interface) 16 through the bus 18, and is connectable to the network N1 or the network N2 in the store through the communication I/F 16.

In addition, the control unit 11 is connected to the storage unit 17 through the bus 18. The storage unit 17 is, for example, an auxiliary storage device such as Hard Disk Drive (HDD) or Solid State Drive (SSD). The storage unit 17 stores a control program 17a for performing various POS processing including the merchandise sales data processing. The control unit 11 performs the merchandise sales data processing or processing related the receipt information, using the control program 17a. The storage unit 17 stores various data files related to the merchandise sales data processing, such as a merchandise data file in which the merchandise data (name, merchandise code, and unit price of each of the merchandise) is stored.

In addition, the storage unit 17 stores an electronic receipt generation program 17b for generating the electronic receipt information based on the receipt information. The control unit 11 executes the electronic receipt generation program 17b, and converts the receipt information in a non-structured format into the electronic receipt information in a structured format based on conversion rules described in a receipt information schema (not illustrated). In such a way, the control unit 11 generates the electronic receipt information from the receipt information.

In addition, the storage unit 17 stores a POS number of the own POS terminal 1 1, a company code (an identification code of the company which operates the store), a business type and business category code, a store code indicating the store P1 in which the POS terminal 1 is disposed, and the like. Here, the business type and business category code, for example, is a code (a sort code) specifying the business type and business category of stores, such as a convenience store, a supermarket, a department store, a pharmacy, a restaurant, and the like. Furthermore, this business type and business category code is arbitrarily changeable according to preference of the user. Alternatively, the company code (the identification code of the company which operates the store) and the business type and business category code may also be registered in the electronic receipt server 3.

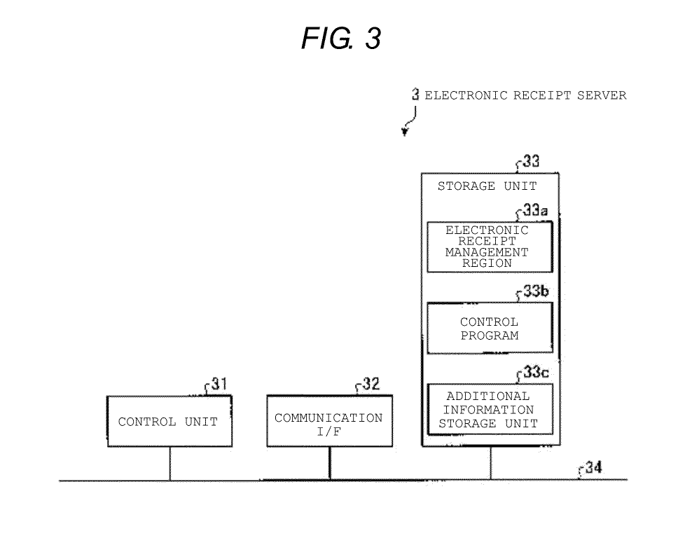

Next, hardware configuration of the electronic receipt server 3, which functions as a receipt management server for a company, will be described with reference to a block diagram of FIG. 3. In FIG. 3, the electronic receipt server 3 includes a control unit 31 which integrally controls various calculations or each unit of the electronic receipt server 3. The control unit 31 includes a CPU, a ROM storing various programs or data, a RAM temporarily storing various programs or rewritably storing various data, an RTC unit indicating current date and time, and the like.

The control unit 31 is connectable to the network N2 or the network N3 through the communication I/F 32 connected to a bus 34. In addition, the control unit 31 is connected to the storage unit 33 through the bus 34.

The storage unit 33 stores the electronic receipt information of a company which operates one or more stores in an electronic receipt management region 33a. The electronic receipt information includes the company code (the identification code of the company which operates the store), the business type and business category code, one or more store codes, membership codes of the shoppers, the POS numbers of the POS terminals 1, the receipt numbers, the merchandise sales data, and the like. In addition, the storage unit 33 stores a control program 33b for managing the electronic receipt information in the electronic receipt management region 33a. In addition, the storage unit 33 includes an additional information storage unit 33c storing the additional information received from the POS terminal 1 or the store server 2.

Next, hardware configuration of the electronic receipt management server 4, which functions as a receipt management server for a customer, will be described with reference to a block diagram of FIG. 4. In FIG. 4, the electronic receipt management server 4 includes a control unit 41 which integrally controls various calculations or each unit of the electronic receipt management server 4. The control unit 41 includes a CPU, a ROM storing various programs or data, a RAM temporarily storing various programs or rewritably storing various data, an RTC unit indicating current date and time, and the like.

The control unit 41 is connectable to the network N3, the network N4, and the network N5 through a communication I/F 42 connected to a bus 44. In addition, the control unit 41 is connected to a storage unit 43 through the bus 44.

In the storage unit 43, an electronic receipt management region 43a, an additional information storage region 43b, and a customer management region 43d are prepared. In addition, in the storage unit 43, a control program 43c is stored. The electronic receipt management region 43a is used to manage the electronic receipt information of multiple companies, each operating one or more stores, with respect to each member of the electronic receipt system. The electronic receipt information is received from the electronic receipt server 3.

The electronic receipt includes a membership code, a company code (the identification code of the company which operates the store), a store code, a POS number of the POS terminal 1, a receipt number, merchandise sales data (including date and time data), and the like. Therefore, for example, a manufacturer of consumer goods or the like may acquire certification of purchase of its products from the electronic receipt information under specific conditions (for example, company which operates the store, location, time, and the like). Furthermore, the manufacturer of consumer goods includes a manufacturer of food, drink, clothing, cosmetics, drug, house hold goods, and the like.

In addition, the storage unit 43 receives various additional information from the electronic receipt server 3 related to particular merchandise (merchandise code), a particular membership (membership code), a particular company (company code), and a particular store (store code), and stores the additional information in the additional information storage region 43b. Here, the additional information includes information of the special on-sale merchandise or particular merchandise, coupon information of particular merchandise, and the like. The additional information is, for example, associated with a promotional program correlated with specific conditions (for example, a specific company operating the store, a specific location, a specific store, a specific time, and the like). In the additional information storage region 43b, the additional information provided in all of the stores managed by the electronic receipt center P3 is stored for each store specified by the store code.

In addition, the storage unit 43 stores the control program 43c for controlling the electronic receipt management region 43a, the additional information storage region 43b, and the like. In addition, the storage unit 43 contains the customer management region 43d for managing information of customers who carries the mobile terminal 7. In the customer management region 43d, various kinds of customer information and a terminal code (SRIC) specifying the mobile terminal 7 carried by the customer are stored in association with a customer ID. The customer ID and the SRID are stored in correlation with each other.

Next, the additional information storage region 43b storing the additional information will be described with reference to FIG. 5. In FIG. 5, the additional information storage region 43b includes a store section 43b1, a special sale information section 43b2, a new merchandise information section 43b3, and a coupon information section 43b4.

The store section 43b1 stores a store code and a store name of all stores of which additional information is stored in the additional information storage region 43b with respect to each store. The special sale information section 43b2 stores information (special sale information) of special sale merchandise, period of the special sale, and the like with respect to each store code stored in the store section 43b1. The new merchandise information section 43b3 stores information (new merchandise information) of new merchandise with respect to each store code stored in the store section 43b1. The coupon information section 43b4 stores coupon information with respect to each store code stored in the store section 43b1 in association with the special sale merchandise information stored in the special sale information section 43b2 or the new merchandise information stored in the new merchandise information section 43b3. The coupon information is stored in correlation with the special sale merchandise information or the new merchandise information, and when the special sale merchandise or the new merchandise is specified, the corresponding coupon information may be specified.

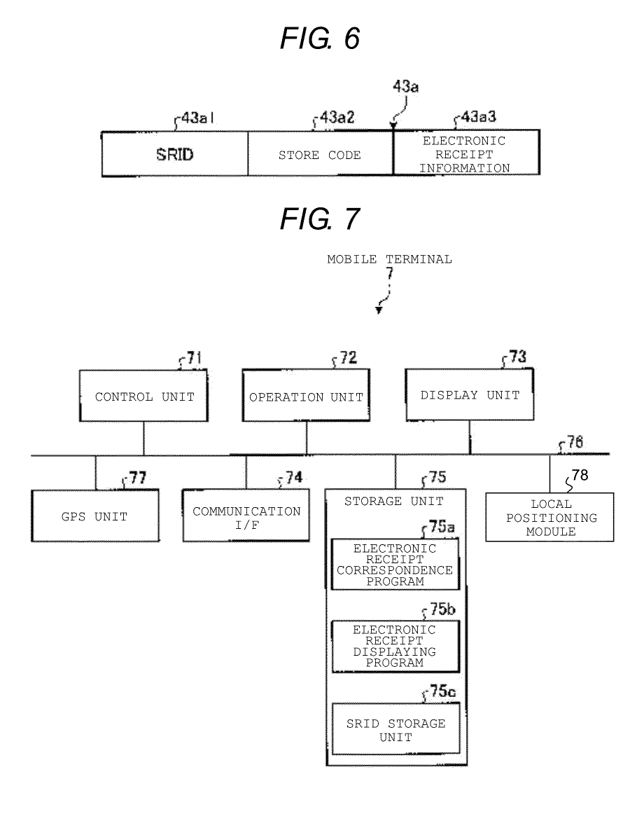

Next, the electronic receipt management region 43a will be described with reference to FIG. 6. In FIG. 6, the electronic receipt management region 43a stores the electronic receipt information generated in the transaction, with respect to each transaction. The electronic receipt management region 43a includes an SRID section 43a1 storing an electronic receipt ID (hereinafter, “SRID”), which is a terminal code specifying the mobile terminal 7 transmitting the electronic receipt, a store code section 43a2, and an electronic receipt information section 43a3. The SRID section 43a1 stores the SRID, which is read out by the code read unit 15 of the POS terminal 1. The store code section 43a2 stores the store code specifying the store P1 at which the transaction is carried out using the POS terminal 1 located therein with respect to each SRID. The electronic receipt information section 43a3 stores the electronic receipt information which is converted from receipt information with respect to each transaction, in association with the SRID. Furthermore, FIG. 6 illustrates the electronic receipt information corresponding to one transaction.

Next, a configuration of the mobile terminal 7 will be described with reference to a block diagram of FIG. 7. In FIG. 7, the mobile terminal 7 includes a control unit 71 which integrally controls various calculations or each unit of the mobile terminal 7. The control unit 71 includes a CPU, a ROM storing various programs or data, a RAM temporarily storing various programs or rewritably storing various data, an RTC unit indicating current date and time, and the like.

An operation unit 72 is connected to a display unit 73 through a bus 76. The operation unit 72 includes various operation keys for the operator (the customer) performing input operation and a pointing device. The display unit 73 is, for example, a liquid crystal display or the like, and displays various kinds of information including the electronic receipt information. Furthermore, the display unit 73 may have a touch panel, and in this case, the touch panel functions as the operation unit 72.

In addition, the control unit 71 is connected to a communication I/F 74 through the bus 76, and is connectable to the network N5 through the communication I/F 74. Furthermore, the control unit 71 maybe connected to the network N1 in the store through the communication I/F 74.

In addition, the control unit 71 is connected to the storage unit 75 through the bus 76. The storage unit 75 includes an electronic receipt correspondence program 75a for receiving the electronic receipt information from the electronic receipt management server 4, an electronic receipt displaying program 75b for displaying the received receipt information, and a SRID storage unit 75c storing the SRID for specifying the mobile terminal 7 that transmits the electronic receipt information, in addition to the Web browser for displaying various kinds of information (content) uploaded on the Web. The SRID stored in the SRID storage unit 75c is displayed on the display unit 73 by a code symbol. The POS terminal 1 reads the code symbol displayed on the display unit 73 using the code read unit 15, and recognizes the SRID.

Furthermore, the SRID may be magnetically or electrically read by the POS terminal 1 other than being read as the code symbol. In addition, for example, the SRID may be read from a membership card or the like in addition to the mobile terminal 7. In addition, the customer ID specifying the customer may be read in addition to the SRID. In this case, the SRID stored in the corresponding electronic receipt management server 4 may be acquired based on the read customer ID.

In addition, the mobile terminal 7 includes the GPS unit 77, which is connected to the bus 76. GPS is a global positioning system which receives a signal from a plurality of satellites using a GPS receiver, and indicates a current position of a recipient. The GPS unit 77 is the GPS receiver, and receives the signal output from the plurality of GPS satellites 8 and specifies the position of the mobile terminal 7.

FIG. 8 illustrates three different locations of the mobile terminal 7, within store X, outside of store X but within range of beacons 9, and outside of store X but close to another store, e.g., store Z. When the mobile terminal 7 is within store X that has a plurality of beacons 9 (shown in FIG. 8 as mobile terminal A), the local positioning module 78 of the mobile terminal 7 is able to determine from detection of the local positioning signals from beacons 9 that the mobile terminal 7 is within store X. For example, when the mobile terminal 7 receives the local positioning signals of a predetermined signal strength or higher from at least a predetermined number of the beacons 9 (e.g., at least three), the local positioning module 78 of the mobile terminal 7 determines that the mobile terminal 7 is within store X. By contrast, when the mobile terminal 7 is outside store X (shown in FIG. 8 as mobile terminal B) but close thereto, the mobile terminal 7 may still detect the local positioning signals from some of the beacons 9. For example, when the mobile terminal 7 receives the signals of the predetermined signal strength or higher from some, but less than the predetermined number, of the beacons 9, the mobile terminal 7 determines that the mobile terminal 7 is outside but close to the store X. On the other hand, when the mobile terminal 7 receives no signals of the predetermined signal strength or higher from the beacons 9 (shown in FIG. 8 as mobile terminal C), the mobile terminal 7 determines that the mobile terminal is not close to any store.

When each of stores X, Y, and Z has the beacons 9, the mobile terminal 7 can determine its location relative to the stores X, Y, and Z (e.g., within store X, Y, or Z, between stores X and Y, nearest store Z, etc.) based on the location positioning signals from the beacons 9 at each of the stores X, Y, and Z. After determining the location of the mobile terminal 7 with respect to a particular store through its local positioning module 78, the mobile terminal 7 transmits such position information to the electronic receipt management server 4 through the network N5. The location determination and transmission is carried out periodically.

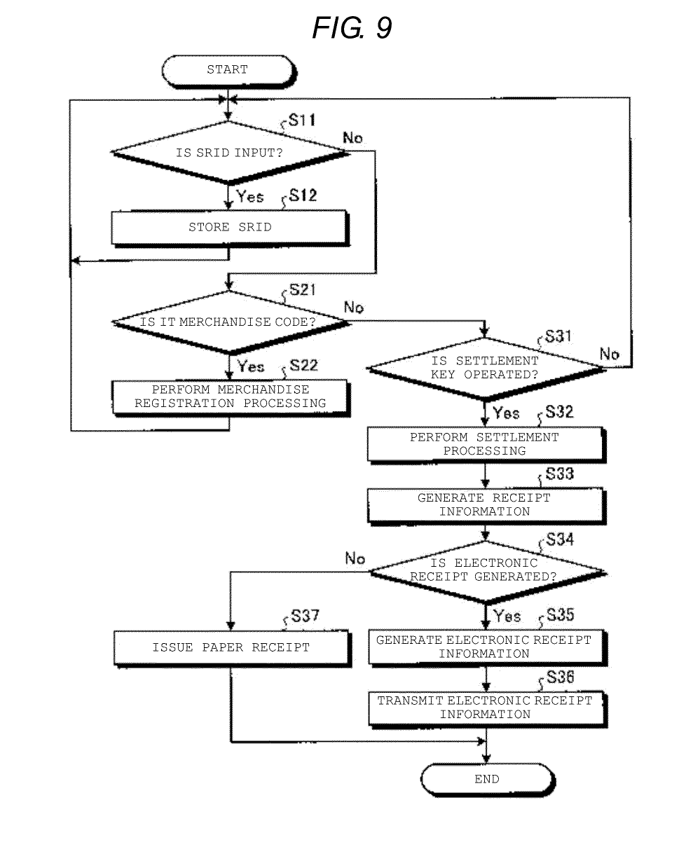

Next, control processing performed by each unit of the electronic receipt system according to this embodiment will be described with reference to FIG. 9 to FIG. 14.

First, control processing performed by the control unit 11 of the POS terminal 1 according to the control program 17a will be described with reference to a flowchart illustrated in FIG. 9.

In FIG. 9, the control unit 11 of the POS terminal 1 determines whether or not the SRID stored in the mobile terminal 7 is read by the code read unit 15 (Step S11). When it is determined that the SRID is read (Yes of Step S11), the control unit 11 stores the read SRID in a SRID storage unit (not illustrated) in the RAM of the control unit 11 (Step S12). Then, the control unit 11 returns to Step S11, and goes into a standby state.

In addition, when it is determined that the SRID stored in the mobile terminal 7 is not read (No of Step S11), the control unit 11 determines whether or not the code symbol assigned to the merchandise is read and the merchandise code is read by the code read unit 15 (Step S21). When it is determined that the merchandise code is read (Yes of Step S21), the control unit 11 performs merchandise registration processing based on the merchandise code (Step S22). Then, the control unit 11 returns to Step S11 and goes into a stands state.

During the merchandise registration processing, a merchandise master (not illustrated) stored in the storage unit 17 is retrieved based on the read merchandise code, and the merchandise information (the merchandise name, the unit price, property information, and the like) stored in the merchandise master is extracted in response to the read merchandise code and is stored in a merchandise information unit (not illustrated) disposed in the RAM or the storage unit 17.

When it is determined that the merchandise code is not read (No of Step S21), the control unit 11 determines whether or not the settlement key 121 is operated (Step S31). When it is determined that the settlement key 121 is operated (Yes of Step S31), the control unit 11 performs settlement processing of the transaction (Step S32). The settlement processing indicates processing in which a total price is calculated and displayed on the display unit 14 based on the merchandise information stored in the merchandise information unit, and the transaction is terminated based on the payment in various methods. Then, the control unit 11 generates the receipt information to be printed on receipt paper based on the settlement information related the transaction (Step S33). Furthermore, when the SRID is stored in the SRID storage unit 75c, in Step S33, the receipt information including the SRID captured therein is generated.

Next, the control unit 11 determines whether or not the electronic receipt information is generated based on the receipt information (Step S34). When the SRID is included in the generated receipt information, the control unit 11 determines that the electronic receipt information is generated.

When it is determined that the electronic receipt information is generated (Yes of Step S34), the control unit 11 executes the electronic receipt generation program 17b, and generates the electronic receipt information based on the receipt information generated in Step S33 (Step S35). In the generated electronic receipt information, the SRID and the store code of the store P1 at which the POS terminal 1 is located are included. Then, the control unit 11 transmits the generated electronic receipt information including the SRID and the store code to the electronic receipt server 3 (Step S36). Then, the control unit 11 terminates the processing.

In contrast, when it is determined that the electronic receipt information is not generated based on the receipt information (that is, the SRID is not included in the receipt information generated in Step S33) (No of Step S34), the control unit 11 controls the printing unit 13 to perform the printing based on the receipt information generated in Step S33, and issue a paper receipt (Step S37). Then, the control unit 11 terminates the processing. Furthermore, in Step S31, when it is determined that the settlement key 121 is not operated (No of Step S31), the control unit 11 returns to Step S11 and goes into a standby state.

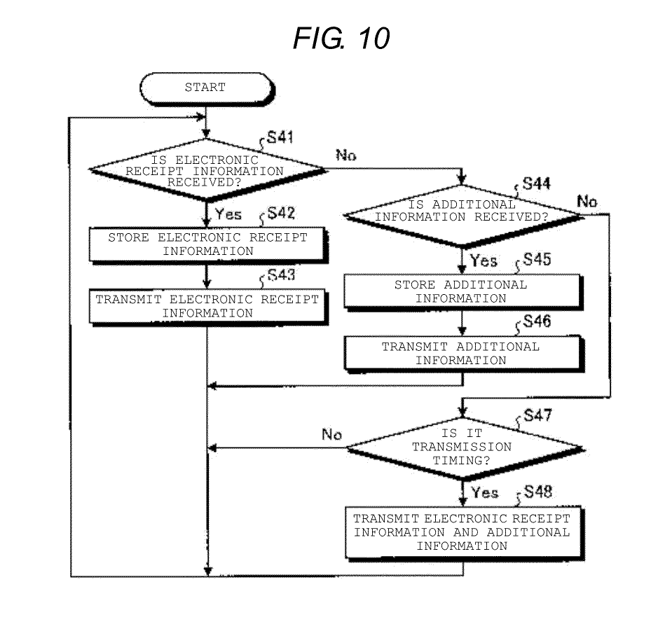

Next, a flow of electronic receipt management processing which is performed when the control unit 31 of the electronic receipt server 3 executes the control program 33b will be described with reference to a flowchart illustrated in FIG. 10.

The control unit 31 of the electronic receipt server 3 determines whether or not the electronic receipt information transmitted from the POS terminal 1 in Step S36 is received through the communication I/F 32 (Step S41). When it is determined that the electronic receipt information is received (Yes of Step S41), the electronic receipt information is stored in the electronic receipt management region 33a of the storage unit 33 as electronic receipt information for the corresponding company (Step S42). Then, the control unit 31 transmits the electronic receipt information stored in Step S42 to the electronic receipt management server 4 (Step S43), and returns to Step S41.

When it is determined that the electronic receipt information is not received (No of Step S41), the control unit 31 determines whether or not the additional information is received from the store server 2 or the POS terminal 1 (Step S44). When it is determined that the additional information is received (Yes of Step S44), the control unit 31 stores the received additional information in the additional information storage unit 33c (Step S45). The additional information is stored with respect to each store code, which specifies the store. Then, the stored additional information is transmitted to the electronic receipt management server 4 (Step S46). Then, the control unit 31 returns to Step S41 and goes into a standby state.

In addition, when it is determined that the additional information is received from none of the store server 2 and the POS terminal 1 (No of Step S44), the control unit 31 determines whether or not a transmission timing which is set in advance comes (Step S47). When it is determined that the transmission timing comes (Yes of Step S47), the control unit 31 transmits the electronic receipt information, which is stored and managed in the electronic receipt management region 33a, and the additional information, which is stored in the additional information storage unit 33c to the electronic receipt management server 4 (Step S48), and returns to Step S41. According to the transmission of Step S48, for example, the electronic receipt information which is out of a transmission target in Step S43 is able to be transmitted to the electronic receipt management server 4. In addition, the additional information which is out of a transmission target in Step S46 is able to be transmitted to the electronic receipt management server 4.

When it is determined that the transmission timing which is set in advance does not come (No of Step S47), the control unit 31 returns to Step S41 and goes into a standby state.

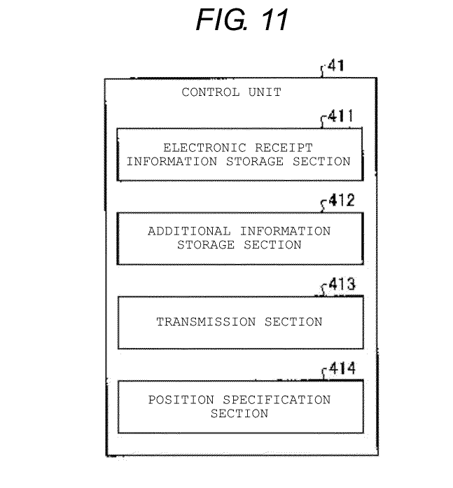

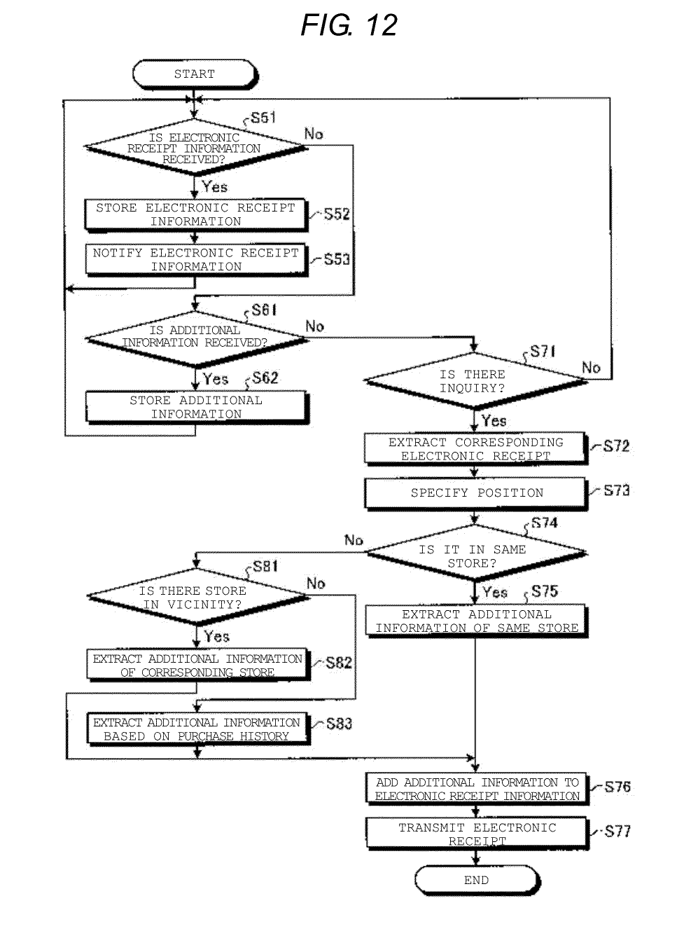

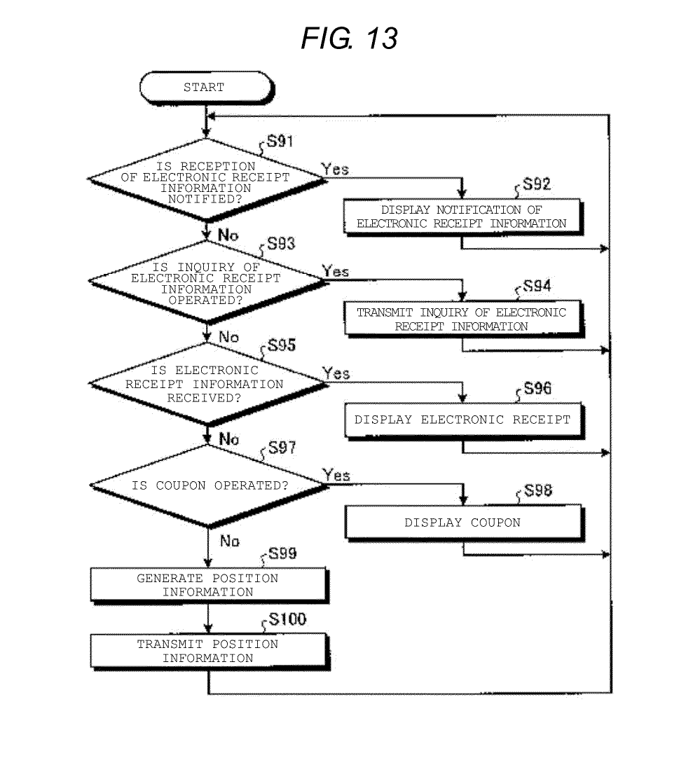

Next, electronic receipt control processing performed when the control unit 41 of the electronic receipt management server 4 executes the control program 43c will be described with reference to a functional block diagram illustrated in FIG. 11 and a flowchart illustrated in FIG. 12.

As illustrated in FIG. 11, when the control program 43c is executed by the electronic receipt management server 4, electronic receipt information storage section 411, additional information storage section 412, transmission section 413, and position specification section 414 are generated. As actual hardware, the CPU of the control unit 41 reads the control program 43c from the storage unit 43 and executes the program, and as a result the electronic receipt information storage section 411, the additional information storage section 412, the transmission section 413, and the position specification section 414 are generated.

The electronic receipt information storage section 411 has a function of storing the electronic receipt information in which the receipt information related sale of the merchandise is included.

The additional information storage section 412 has a function of storing plural pieces of additional information corresponding to the electronic receipt information, in accordance with predetermined delivery conditions to the mobile terminal 7 carried by the customer.

The transmission section 413 has a function of transmitting the additional information satisfying the delivery conditions to the mobile terminal 7 to the mobile terminal 7 along with the electronic receipt information.

The position specification section 414 has a function of specifying the position of the mobile terminal 7 based on GPS information received from the outside.

FIG. 12 is a flowchart illustrating control processing of the electronic receipt management server 4. In FIG. 12, the control unit 41 determines whether or not the electronic receipt information is received from the electronic receipt server 3 (Step S51). When it is determined that the electronic receipt information is received (Yes of Step S51), the control unit 41 (the electronic receipt information storage section 411) stores the electronic receipt information including the SRID and the store code in the electronic receipt management region 43a (Step S52). Then, the control unit 41 transmits notification indicating that the electronic receipt management server 4 has received the electronic receipt information, and the electronic receipt information may be transmitted to the address or the like associated with the mobile terminal 7 specified by the SRID which is stored in the customer management region 43d, in response to the SRID included in the received electronic receipt information (Step S53). Then, the control unit 41 returns to Step S51 and goes into a standby state.

In addition, when it is determined that the electronic receipt information is not received from the electronic receipt server 3 (No of Step S51), the control unit 41 determines whether or not the additional information, which is transmitted in Step S46 or Step S48, is received (Step S61). When it is determined that the additional information is received (Yes of Step S61), the control unit 41 (the additional information storage section 412) stores the received additional information in the additional information storage region 43b (Step S62). Then, the control unit 41 returns to Step S51 and goes into a standby state.

When it is determined that the additional information is not received (No of Step S61), the control unit 41 determines whether or not there is an inquiry of the electronic receipt information from the mobile terminal 7 (Step S71). The inquiry of the electronic receipt information is performed by operating the mobile terminal 7 in which the notification of Step S53 is received (the details will be described below with reference to FIG. 13).

When it is determined that there is the inquiry of the electronic receipt information (Yes of Step S71), the control unit 41 extracts the electronic receipt information which is inquired, from the electronic receipt management region 43a (Step S72). Then, the control unit 41 (the position specification section 414) specifies a current position of the mobile terminal 7 based on the SRID and the store code stored in the extracted electronic receipt information (Step S73).

Specifically, the control unit 41 receives the SRID and the position information which are periodically transmitted from the mobile terminal 7 (both the position information based on the GPS satellite 8 and the position information based on the beacons 9), and specifies the position of the mobile terminal 7 based on the position information of the mobile terminal 7 which is specified by a SRID identical to the SRID extracted in Step S72.

Then, the control unit 41 determines whether or not the mobile terminal 7 is positioned in the store P1 in which the inquired electronic receipt is generated, based on the obtained position information of the mobile terminal 7 and the extracted store code described above (Step S74). When the obtained position information of the mobile terminal 7 is in the store P1 specified by the extracted store code, the control unit 41 determines that the mobile terminal 7 is positioned in the store P1 in which the inquired electronic receipt is generated.

When it is determined that the mobile terminal 7 is positioned in the store P1 in which the inquired electronic receipt is generated (Yes of Step S74), the control unit 41 extracts the additional information stored in the additional information storage region 43b, which corresponds to the electronic receipt information specified by the SRID, stored in the electronic receipt management region 43a (Step S75).

Specifically, the control unit 41 extracts the store specified by the store code from the store unit 43b1 and extracts the special sale information of the store which is stored in the corresponding special sale information unit 43b2. Also, the control unit 41 extracts the new merchandise information of the store which is stored in the corresponding new merchandise information unit 43b3, and the coupon information applicable to the merchandise of the special sale information or the new merchandise information described above which is stored in the corresponding coupon information unit 43b4.

In the present embodiment, only information of the merchandise associated with the purchased merchandise in the electronic receipt information may be extracted among all special sale information of the store which are stored in the special sale information unit 43b2, all new merchandise information of the store which are stored in the new merchandise information unit 43b3, and all coupon information which are stored in the coupon information unit 43b4. In addition, only information of merchandise of which the sales is particularly planned to be advertised by the store may be extracted. Insofar as the information is related the merchandise sold in the store, the information may be extracted in accordance with various conditions.

Next, the control unit 41 adds the additional information extracted in Step S75 to the inquired electronic receipt information (Step S76). Then, the control unit 41 (the transmission section 413) transmits the electronic receipt information to which the additional information has been added to the mobile terminal 7 associated with the corresponding SRID (Step S77).

On the other hand, as a result of Step S73, when it is determined that the mobile terminal 7 is not positioned in the store P1 for which the inquired electronic receipt has been generated (that is, the mobile terminal 7 is positioned outside the store P1) (No of Step S74), the control unit 41 determines whether or not a store that has a relationship with the store P1 (such as chain stores) exists in the vicinity of the position of the mobile terminal 7 determined in Step S73 (Step S81). When a distance between the position of the mobile terminal 7 determined in Step S73 and the store of the other store is within a predetermined range (for example, within 1 kilometer), the control unit 41 determines that the other store exists in the vicinity of the position of the mobile terminal 7.

When it is determined that the other store exists in the vicinity of the position of the mobile terminal 7 (Yes of Step S81), the control unit 41 acquires the store code of the other store, and extracts the special sale information, the new merchandise information, and/or the coupon information which are stored in the additional information storage region 43b in association with the other store (Step S82). Then, the control unit 41 performs the processes after Step S76.

In addition, when it is determined that the other store does not exist in the vicinity of the position of the mobile terminal 7 (No of Step S81), the control unit 41 searches the customer management region 43d, extracts past purchase history information of the customer of the mobile terminal 7 specified by the SRID, and extracts merchandise information of merchandise which has been purchased in a large quantity in the past, merchandise which has been purchased during a predetermined period, or the like, or the coupon information related the merchandise information (Step S83). Then, the control unit 41 performs the processes after Step S76.

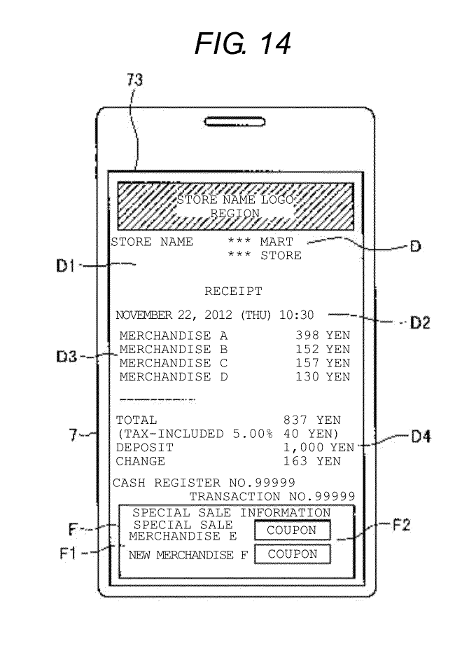

Next, a flow of electronic receipt reception processing which is performed when the control unit 71 of the mobile terminal 7 executes the electronic receipt correspondence program 75a and a flow of electronic receipt display processing which is performed when the control unit 71 executes the electronic receipt displaying program 75b will be described with reference to FIG. 13 and FIG. 14.

As illustrated in FIG. 13, the control unit 71 determines whether or not a notification of reception of the electronic receipt information is received from the electronic receipt management server 4 (Step S91). When it is determined that the notification is received (Yes of Step S91), the control unit 71 displays the received notification on the display unit 73 (Step S92).

When it is determined that the notification is not received (No of Step S91), the control unit 71 determines whether or not an inquiry of the electronic receipt information is operated (Step S93). The operator of the mobile terminal 7, after confirming the notification, operates the operation unit 72 to transmit an inquiry of the electronic receipt information. When it is determined that the operation unit 72 is operated (Yes of Step S93), the control unit 71 transmits the inquiry to the electronic receipt management server 4 (Step S94). The electronic receipt management server 4 that has received the inquiry performs processing of Step S71 to Step S83 of FIG. 12, and transmits the electronic receipt information and the additional information to the mobile terminal 7.

In contrast, when it is determined that the inquiry of the electronic receipt information is not operated (No of Step S93), the control unit 71 determines whether or not the electronic receipt information and the additional information are received from the electronic receipt management server 4 (Step S95). When it is determined that the electronic receipt information and the additional information are received (Yes of Step S95), the control unit 71 displays the received electronic receipt information and additional information on the display unit 73 (Step S96). Furthermore, when only the electronic receipt information is received, the control unit 71 displays only the electronic receipt information.

Here, in FIG. 14, the electronic receipt information and the additional information displayed in Step S96 is illustrated. In FIG. 14, the electronic receipt information, and the additional information which is extracted in Step S75 when it is determined that the mobile terminal 7 is located in the store in Step S74 are displayed as an example. In FIG. 14, the control unit 71 displays electronic receipt information D and additional information F on the display unit 73 of the mobile terminal 7. The control unit 71 displays a shop name and a shop name logo D1 of the store in which the merchandise has been purchased, a date and time D2 of the transaction, merchandise information D3 such as the merchandise name or the price of the merchandise, settlement information D4 such as a total price or a change, and the like, as the electronic receipt information D.

In addition, the control unit 71 displays special sale merchandise information F1 of the merchandise which is specially sold in the store and coupon information F2 of a coupon available for the special sale merchandise which is set in association with the special sale merchandise information F1, as the additional information F. The special sale merchandise information F1 is related to the special sale merchandise associated with the merchandise information D3 displayed as the electronic receipt information.

The description will return to FIG. 13. When it is determined that the control unit 71 has not received the electronic receipt information and the additional information (No of Step S95), the control unit 71 determines whether or not the coupon is selected through a user's touch operation of the displayed coupon information F2 (Step S97).

When it is determined that the coupon is operated (Yes of Step S97), the control unit 71 expands an image of the operated coupon information on the display unit 73 (Step S98). When the coupon information F2 is touched, the coupon of the special sale merchandise can be enlarged. As a result, when the operator of the mobile terminal 7 wants to use the coupon, a larger image of the coupon can be displayed and a salesperson confirms the coupon more easily.

In addition, when it is determined that the coupon is not operated (No of Step S97), the control unit 71 generates the position information of the position at which the mobile terminal 7 is currently located based on a GPS signal received from the GPS unit 77 and the signal received from the beacons 9, if any (Step S99). Then, the control unit 71 transmits the generated position information to the electronic receipt management server 4 through the network N5 (Step S100).

According to the above embodiment, the electronic receipt management server 4 determines whether or not the mobile terminal 7 is located in the store, or whether or not the mobile terminal 7 is located in the vicinity of the other store related to the store. When the mobile terminal 7 is determined to be located in the store, additional information of the store is transmitted, and when the mobile terminal 7 is determined to be located in the vicinity of the other store, additional information of the other store is transmitted. In other situation, additional information related to the purchase history is transmitted. As a result, it is possible to transmit suitable additional information based on a location of the mobile terminal 7, that is, a location of the customer carrying the mobile terminal 7.

In the embodiment described above, the position of the mobile terminal 7 is specified using a GPS unit. Alternatively, the position of the mobile terminal 7 may be specified by other methods, for example, based on a communication between the mobile terminal 7 and a base station and a location of the base station.

In addition, in the embodiment described above, the special sale merchandise information, the new merchandise information, and the coupon information are used as the additional information. Alternatively, other information related the merchandise may be used as the additional information.

In addition, in the embodiment, the type of additional information to be transmitted is changed based on the position information of the mobile terminal 7. Alternatively, the additional information to be transmitted may be changed based on information other than the position information (for example, an elapsed time after purchasing the merchandise).

Furthermore, a program executed by the electronic receipt management server according to the embodiment is stored in a non-transitory storage medium such as CD-ROM, flexible disk (FD), CD-R, or Digital Versatile Disk (DVD) which is readable by a computer in a file of an installable format or an executable format.

Alternatively, the program executed by the electronic receipt management server according to the embodiment may be stored on a computer connected to a network such as the Internet, and may be provided by being downloaded through the network. In addition, the program executed by the electronic receipt management server according to the embodiment may be provided or distributed through the network such as the Internet.

In addition, the program executed by the electronic receipt management server according to the embodiment may be provided by being incorporated in a ROM or the like in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system for wirelessly transmitting transaction data to a mobile computing device carried by a user, comprising:
a server storing transaction data of a purchase transaction carried out by the user at a store, first additional information associated with the store, and second additional information that is different from the first additional information;
a local positioning system of the store; and
a mobile computing device of the user configured to determine whether or not the mobile computing device is within the store based on one or more local positioning signals received from the local positioning system and transmit position information of the mobile computing device including the determination result to the server, wherein
the server is configured to transmit, to the computing device, the transaction data and the first additional information when the position information indicates that the mobile computing device is within the store, and the transaction data and the second additional information when the position information indicates that the mobile computing device is outside the store.

2. The system according to claim 1, wherein
the local positioning system includes a store server and a plurality of beacons located in the store, each of the beacons being configured to generate a local positioning signal, and
the mobile computing device accesses the store server in response to detecting the local positioning signal, and then receives identification information of the store from the store server.

3. The system according to claim 2, wherein
the mobile computing device determines that the mobile computing device is within the store when the number of the local positioning signals received from the beacons is equal to or greater than a predetermined number, and that the mobile computing device is outside the store when the number of the local positioning signals received from the beacons is smaller than the predetermined number.

4. The system according to claim 1, wherein
the mobile computing device is further configured to receive a global positioning signal from a global positioning system, and
the position information includes global position information of the mobile computing device based on the global positioning signal.

5. The system according to claim 4, wherein
the mobile computing device transmits the position information periodically to the server.

6. The system according to claim 4, wherein
the server is further configured to determine whether or not there is another store within a predetermined distance from a current position of the mobile computing device based on the position information, when the position information indicates that the mobile computing device is outside the store,
the second additional information is associated with said another store, and
the second additional information is transmitted to the mobile computing device when it is determined that there is another store.

7. The system according to claim 6, wherein
the server stores third additional information different from the first and second additional information, and transmits the third additional information to the mobile computing device when it is determined that there is no other store within the predetermined distance.

8. The system according to claim 7, wherein
the third additional information is associated with a purchase history of the user.

9. The system according to claim 1, wherein
the first additional information includes at least one of information related to a discounted product registered for sale in the store, information related to a new product registered for sale in the store, and information related to a coupon available in the store.

10. A method for wirelessly transmitting transaction data to a mobile computing device carried by a user, the method comprising:
storing, in a sever, transaction data of a purchase transaction carried out by the user at a store, first additional information associated with the store, and second additional information that is different from the first additional information;
determining whether or not the mobile computing device is within the store based on one or more local positioning signals from a local positioning system of the store;
transmitting, from the mobile computing device to the server, position information of the mobile computing device including the determination result; and
transmitting, from the server to the mobile computing device, the transaction data and the first additional information when the position information indicates that the mobile computing device is within the store, and the transaction data and the second additional information when the position information indicates that the mobile computing device is outside the store.

11. The method according to claim 10, wherein
the local positioning system includes a store server and a plurality of beacons located in the store, each of the beacons being configured to generate a local positioning signal, the method further comprising:
accessing the store server from the mobile computing device, in response to detecting one or more local positioning signals from the beacons; and
receiving identification information of the store from the store server, in response to the access.

12. The method according to claim 11, wherein
the mobile computing device is determined to be within the store when the number of local positioning signals received from the beacons is equal to or greater than a predetermined number, and outside the store when the number of local positioning signals received from the beacons is smaller than the predetermined number.

13. The method according to claim 10, further comprising:
receiving, at the mobile computing device, a global positioning signal from a global positioning system, wherein
the position information includes global position information of the mobile computing device based on the global positioning signal.

14. The method according to claim 13, wherein
the position information is periodically transmitted to the server from the mobile computing device.

15. The method according to claim 14, further comprising:
determining whether or not there is another store within a predetermined distance from a current position of the mobile computing device based on the position information, when the position information indicates that the mobile computing device is outside the store, wherein
the second additional information is associated with said another store, and
the second additional information is transmitted to the mobile computing device when it is determined that there is another store.

16. The method according to claim 15, further comprising:
storing, in the sever, third additional information different from the first and second additional information; and
transmitting the third additional information to the mobile computing device when it is determined that there is no store within the predetermined distance.

17. The method according to claim 16, wherein
the third additional information is associated with a purchase history of the user.

18. The method according to claim 10, wherein
the first additional information includes at least one of information related to a discounted product registered for sale in the store, information related to a new product registered for sale in the store, and information related to a coupon available in the store.

19. A system for wirelessly transmitting transaction data to a mobile computing device carried by a user, comprising:
a server storing transaction data of a purchase transaction carried out by the user; and
a mobile computing device of the user configured to determine a position of the mobile computing device based on a global positioning signal received from a global positioning system and transmit position information of the mobile computing device to the server, wherein
the server is configured to transmit, to the mobile computing device, the transaction data and additional information that is determined based on the position information.

20. The system according to claim 19, wherein
the server is further configured to determine whether or not there is a store within a predetermined distance from a current position of the mobile computing device based on the position information,
the additional information is related to the store, when it is determined that there is a store within the predetermined distance.
